(19) United States
(12) Patent Application Publication
(10) Pub. No.: US 2014/0193670 A1
(43) Pub. Date: Jul. 10, 2014

(54) BATTERY PACK

(71) Applicant: Samsung SDI Co., Ltd., Yongin-si (KR)

(72) Inventor: Byung-Kook Ahn, Yongin-si (KR)

(21) Appl. No.: 13/921,160

(22) Filed: Jun. 18, 2013

(30) Foreign Application Priority Data
Jan. 10, 2013 (KR) 10-2013-0003145

(51) Int. Cl. H01M 10/42

(52) U.S. Cl. CPC H01M 10/4257
USPC 429/7

(57) ABSTRACT

A battery pack including a battery cell; a protection circuit module (PCM) electrically coupled to the battery cell; a case including internally defined positions for housing the battery cell and the PCM and having a hole; a connector extending through the hole and protruding from the case, the connector electrically coupling the battery cell to an external device; and a sealing member located substantially parallel to an extending direction of the connector and adjacent to an inner side of the case and sealing the hole.

### CROSS-REFERENCE TO RELATED PATENT APPLICATIONS

This application claims priority to and the benefit of Korean Patent Application No. 10-2013-0003145, filed on Jan. 10, 2013, in the Korean Intellectual Property Office, the disclosure of which is incorporated herein in its entirety by reference.

### BACKGROUND

1. Field

One or more embodiments of the present invention relate to a battery pack.

2. Description of the Related Art

Due to developments in wireless internet and communication technologies, portable computers such as a tablet PCs, notebooks, and the like, which may be powered using a battery without a separate power supply unit, have rapidly become widespread. In general, a portable computer is small, convenient, and portable and thus is widely used for business purposes or personal use. In order for a user to use the portable computer in various places without restriction due to a power supply unit, the portable computer may include an embedded battery pack. The battery pack may include a secondary battery capable of being repeatedly charged and discharged.

### SUMMARY

One or more aspects of one or more embodiments of the present invention are directed toward a battery pack, and more specifically, a battery pack having a particular structure.

Additional aspects will be set forth in part in the description which follows and, in part, will be apparent from the description, or may be learned by practice of the presented embodiments and their equivalents.

According to one or more embodiments of the present invention, a battery pack includes a battery cell; a protection circuit module (PCM) electrically coupled to the battery cell; a case including internally defined positions for housing the battery cell and the PCM and having a hole; a connector extending through the hole and protruding from the case, the connector electrically coupling the battery cell to an external device; and a sealing member in the case and located substantially parallel to an extending direction of the connector and adjacent to an inner side of the case and sealing the hole.

The hole may be in a side of the case, and the side extends in a thickness direction of the case.

The sealing member may include a fire-retardant material.

A height of the sealing member may be greater than a height of the hole.

A cross-sectional size of the sealing member may be greater than a cross-sectional size of the hole.

A cable may extend from an end of the PCM through the sealing member and electrically couple the PCM to the connector.

The sealing member may be between an end of the PCM and the inner side of the case.

The end of the PCM may contact the sealing member, and a first outer side of the sealing member may contact the inner side of the case.

A first outer side of the sealing member may contact the inner side of the case, and a second outer side of the sealing member, opposite to the first outer side, may face the end of the PCM.

The case may have a frame shape including a side wall extending in a thickness direction and substantially surrounding the battery cell and the PCM, and a lower rib extending vertical to the side wall and may have a space configured for loading the PCM.

According to one or more embodiments of the present invention, a battery pack includes a battery cell; a protection circuit module (PCM) electrically coupled to the battery cell; a case including internally defined positions for housing the battery cell and the PCM and having a hole; a cable coupling a connector to the PCM and protruding through the hole; and a sealing member substantially parallel to a protrusion direction of the connector and sealing the hole.

A first outer side of the sealing member may contact an inner side of the case, and the sealing member may include a fire-retardant material.

A second outer side of the sealing member, opposite to the first outer side, may face an end of the PCM.

The cable may extend through the sealing member.

The hole may be in a side of the case, and the side extends in a thickness direction of the case.

According to one or more embodiments of the present invention, a battery pack includes a battery cell; a protection circuit module (PCM) electrically coupled to the battery cell; a case including internally defined positions for housing the battery cell and the PCM and having a hole; a connector extending through the hole and protruding from the case, the connector electrically coupling the battery cell to an external device; and a sealing member between an end of the PCM and an inner side of the case and sealing the hole.

A cable may electrically couple the connector to the PCM and extend through the sealing member.

A first outer side of the sealing member may contact an inner side of the case.

The sealing member may include a fire-retardant material.

A height of the sealing member may be greater than a height of the hole.

### BRIEF DESCRIPTION OF THE DRAWINGS

These and/or other aspects will become apparent and more readily appreciated from the following description of the embodiments, taken in conjunction with the accompanying drawings of which:

FIG. 1 is an exploded perspective view illustrating a battery pack according to an embodiment of the present invention;

FIG. 2 is a perspective view illustrating a battery cell of the battery pack of FIG. 1;

FIG. 3 is an exploded perspective view illustrating a case and a protection circuit module (PCM) of the battery pack of FIG. 1;

FIG. 4 is a perspective view illustrating the case of FIG. 3 in which the PCM and a connector are assembled; and

FIG. 5 is a cross-sectional view of the assembly of FIG. 4, taken along a line V-V of FIG. 4.

### DETAILED DESCRIPTION

The present invention will now be described more fully with reference to the accompanying drawings, in which exemplary embodiments of the invention are shown.

The invention may, however, be embodied in many different forms, and should not be construed as being limited to the embodiments set forth herein. Thus, the invention may include all revisions, equivalents, or substitutions which are included in the concept and the technical scope related to the invention. Furthermore, all examples and conditional language recited herein are to be construed as being without limitation to such specifically recited examples and conditions. Throughout the specification, a singular form may include plural forms unless there is a particular description contrary thereto. Also, terms such as “comprise” or “comprising” are used to specify the existence of a recited form, a number, a process, an operation, a component, and/or groups thereof, not excluding the existence of one or more other recited forms, one or more other numbers, one or more other processes, one or more other operations, one or more other components, and/or groups thereof. While terms “first” and “second” are used to describe various components, it will be obvious that the components are not limited to the terms “first” and “second”. The terms “first” and “second” are used only to distinguish between each component. For example, a first component may indicate a second component or a second component may indicate a first component without conflicting with the invention.

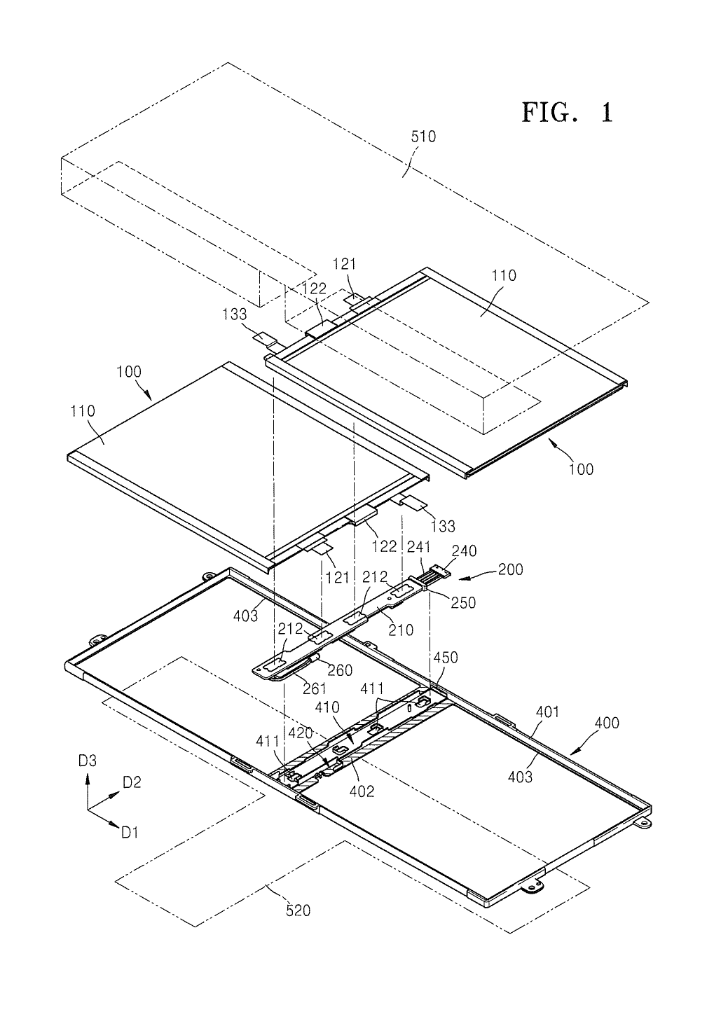

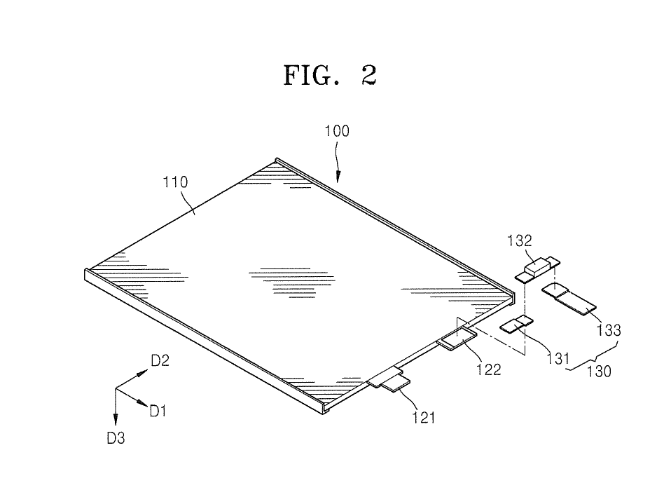

FIG. 1 is an exploded perspective view illustrating a battery pack according to an embodiment of the present invention. FIG. 2 is a perspective view illustrating a battery cell 100 of the battery pack of FIG. 1.

Referring to FIG. 1, the battery pack may include the battery cell 100, a protection circuit module (PCM) 200, a temperature sensor 260, and a case 400.

The battery cell 100 may be a secondary battery cell that can be (e.g., is designed to be) recharged and may be formed of (e.g., include) a lithium-ion battery. The battery cell 100 may include an electrode assembly (not shown) and a pouch 110 for housing (e.g., containing) the electrode assembly. The electrode assembly may have the shape of a jelly roll formed by stacking and then rolling a positive electrode plate, a negative electrode plate, and a separator interposed therebetween. Alternatively, the electrode assembly may be formed by sequentially stacking the positive electrode plate, the separator, and the negative electrode plate a plurality of times. In the present embodiment, the battery cell 100 is embodied as the lithium-ion battery, but the present invention is not limited thereto and thus, in other embodiments, the battery cell 100 may be embodied as a nickel-cadmium battery or a nickel-metal hydride battery.

Referring to FIGS. 1 and 2, a positive electrode tab 121 and a negative electrode tab 122 may extend from a side of the battery cell 100. The positive electrode tab 121 is electrically coupled (e.g., connected) to the positive electrode plate of the electrode assembly, and the negative electrode tab 122 is electrically coupled (e.g., connected) to the negative electrode plate of the electrode assembly.

A temperature cutoff (TCO) assembly 130 may be electrically coupled (e.g., connected) to one of the positive electrode tab 121 and the negative electrode tab 122. The TCO assembly 130 may include a temperature cutoff (TCO) 132 and first and second auxiliary leads 131 and 133 positioned (e.g., located or connected) at side end portions (e.g., opposite end portions) of the TCO 132.

As illustrated in FIG. 2, a left side portion (e.g., a left bottom portion) of the first auxiliary lead 131 is coupled (e.g., connected) to the negative electrode tab 122, and a right side portion (e.g., a right top portion) of the first auxiliary lead 131 is coupled (e.g., connected) to an end portion the TCO 132 (e.g., a left end portion of the TCO 132). An end portion of the second auxiliary lead 133 is coupled (e.g., connected) to an opposite end portion of the TCO 132 (e.g., a right end portion of the TCO 132). The left and right side portions of the first auxiliary lead 131 may be coupled (e.g., connected) to the negative electrode tab 122 and the TCO 132, respectively, by, for example, welding, and the end portion of the second auxiliary lead 133 may be coupled (e.g., connected) to the TCO 132 (e.g., the opposite end portion of the TCO 132) by, for example, welding.

In the present embodiment, the TCO assembly 130 is electrically coupled (e.g., connected) to the negative electrode tab 122 of the battery cell 100, but the present invention is not limited thereto and thus, in another embodiment, the TCO assembly 130 may be electrically connected to the positive electrode tab 121 of the battery cell 100.

A plurality of battery cells 100 may be included in the battery pack, and as illustrated in FIG. 1, when two battery cells 100 are included, the positive and negative electrode tabs 121 and 122 of the battery cells 100 may face each other, and the PCM 200 may be disposed (e.g., formed or located) between the battery cells 100.

The PCM 200 may be electrically connected to the battery cells 100. In an embodiment, each of the positive electrode tab 121 and the negative electrode tab 122 of the battery cell 100 on (e.g., located on) a left side of the PCM 200 may be connected to, for instance, welded, to corresponding connection parts 212 of the PCM 200. Similarly, each of the positive electrode tab 121 and the negative electrode tab 122 of the battery cell 100 on (e.g., located on) a right side of the PCM 200 may be connected to the corresponding connection parts 212 of the PCM 200, so that the PCM 200 and the battery cells 100 may be electrically connected to each other. For example, as described with reference to FIG. 2, when the TCO assembly 130 is connected to the negative electrode tab 122, the positive electrode tab 121 and the second auxiliary lead 133 (e.g., another end portion of the second auxiliary lead 133) of the TCO assembly 130 may be connected (e.g., welded) to the corresponding connection parts 212 of the PCM 200.

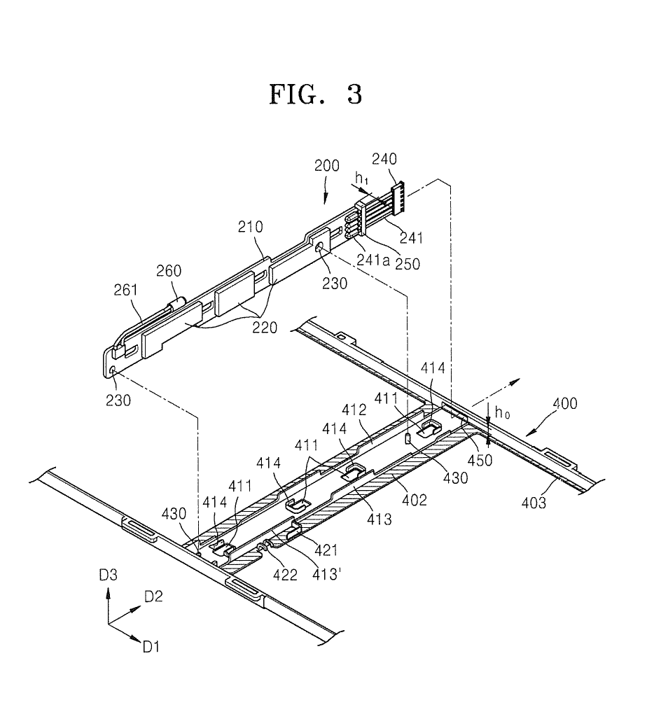

The PCM 200 may prevent (e.g., be configured to prevent) overheating and explosion of the battery cells 100 that may occur due to overcharging, overdischarging, or an overcurrent situation. The PCM 200 may include a substrate 210 and a protective device 220 (refer to FIG. 3) located (e.g., mounted or formed) on the substrate 210. The protective device 220 may be formed (e.g., selectively formed) of a safety device including a passive device, such as a resistor or a condenser, or an active device, such as a field-effect transistor (FET) or integrated circuits (ICs). In the present embodiment, the protective device 220 is mounted on the substrate 210, but the present invention is not limited thereto and thus, in another embodiment, the protective device 220 may be adjacent to (e.g., arranged in) the substrate 210.

The battery pack may be electrically coupled (e.g., connected) to an external device via a connector 240. The external device may include a portable electronic device, such as a notebook computer or a tablet computer which receives power stored in the battery cell 100 or a charging device that charges the battery cell 100.

The connector 240 may be electrically coupled (e.g., connected) to the PCM 200 via a cable 241. For example, the connector 240 may extend in (e.g., along) a longitudinal direction of the PCM 200 via the cable 241 that extends from a side of the PCM 200. An end (e.g., a left end) of the cable 241 may be connected (e.g., welded) to the PCM 200, the connector 240 may be arranged (e.g., located) at another end (e.g., a right end) of the cable 241, and the connector 240 may protrude (e.g., extend or externally protrude) from the case 400 via a hole 450.

A sealing member 250 may be arranged in the same axial-direction as a protrusion direction of the connector 240 (e.g., an extension direction of the connector 240). For example, the sealing member 250 may be interposed (e.g., located or formed) between an end (e.g., a right end) of the PCM 200 and the connector 240. The cable 241 may penetrate (e.g., extend) through the sealing member 250 (e.g., the sealing member 250 may surround a portion of the cable 241).

Because the connector 240 penetrates (e.g., extends) through the hole 450, the sealing member 250 may block (e.g., seal) the hole 450 in the case 400. The connector 240 penetrates through the hole 450, and the PCM 200 is located (e.g., housed or fixed) at a PCM loading structure 410 (e.g., PCM loading unit) that is located (e.g., arranged) in the case 400. A first outer side surface (e.g., first outer side) of the sealing member 250 which faces an inner side surface (e.g., inner side) of the case 400 may block the hole 450 when the first outer side surface of the sealing member 250 contacts the inner side surface of the case 400.

The sealing member 250 may include a fire-retardant material, such as fire-retardant silicone. Because the hole 450 is formed at (e.g., in or through) a side wall 401 of the case 400 along a thickness direction of the battery pack, a size (e.g., cross-sectional area) of the hole 450 may be very small. As a thickness of the battery pack is decreased, a height of the side wall 401 is correspondingly decreased, and the connector 240 protrudes from the case 400 (e.g., is externally exposed) via the hole 450. Accordingly, it is difficult to attach seals (e.g., labels) 510 and 520 around (e.g., around an outer side of) the hole 450. Because it is difficult to attach the seals 510 and 520 at and around the hole 450, it is difficult to ensure fire-retardancy around the hole 450 from which the connector 240 protrudes. However, according to the present embodiment, since the sealing member 250 may be formed of the fire-retardant material and is disposed (e.g., located) in the case 400 so as to block (e.g., seal) the hole 450, a fire-retardant condition (e.g., characteristic or function) of the battery pack may be fulfilled and/or maintained.

The temperature sensor 260 converts (or generates) temperature information at a measurement position to an electrical signal and then transmits the temperature information to the PCM 200. The temperature sensor 260 may be a thermistor. The thermistor may generate the electrical signal that corresponds to a temperature of a measurement target (e.g., location) and/or may be a resistive thermistor whose electrical resistance varies according to a temperature. The temperature sensor 260 may monitor (e.g., perform a monitoring operation to monitor) temperature variation of the battery cell(s) 100, and according to a result of the monitoring operation, charging and discharging of the battery cell 100 may be controlled (e.g., selectively controlled). To do so, the electrical signal that is generated by the temperature sensor 260 may be transmitted to the PCM 200 via a cable 261 that couples (e.g., connects or electrically connects) the temperature sensor 260 and the PCM 200.

The temperature sensor 260 may be positioned in (e.g., along or parallel to) a longitudinal direction of the PCM 200. The temperature sensor 260 may be disposed (e.g., located) adjacent to one of the sides (e.g., longitudinal sides) of the PCM 200, and FIG. 1 illustrates a case in which the temperature sensor 260 is disposed at a right side of the PCM 200.

The temperature sensor 260 may be disposed (e.g., located) adjacent to the positive electrode tab 121 or the negative electrode tab 122 of the battery cell 100. Because the positive electrode tab 121 and the negative electrode tab 122 include a metal material having a high thermal conductivity, a temperature of the battery cell 100 may be entirely detected (e.g., applied) there. In order to rapidly detect an emergency situation in which a temperature is abnormally increased during charging or discharging and to prevent an accident due to, for example, fire or explosion, the temperature sensor 260 may be disposed adjacent to the positive and negative electrode tabs 121 and 122 of the battery cell 100.

The case 400 may define (e.g., have) assembly positions for (e.g., configured for) the battery cells 100 and the PCM 200. The case 400 may include an insulating material. For example, the case 400 may include a polymer compound capable of being molded by, for example, heat or pressure.

The case 400 may have a frame shape that has the side wall 401 surrounding or substantially surrounding the battery cells 100 and the PCM 200, which are both located (e.g. arranged) in the case 400. The side wall 401 may extend in a thickness direction relative to the case 400, and a top surface and a bottom surface of the case 400 may be open or substantially open. A portion of the bottom surface of the case 400 may include a lower rib 402 that is (e.g., extends) vertical relative to the side wall 401 so as to load (e.g., accommodate) the PCM 200.

Because the side wall 401 extends along the thickness direction of the case 400, a height of the side wall 401 may determine a thickness of the battery pack. The hole 450 is formed (e.g., located or disposed) in a surface of the side wall 401 so as to allow the connector 240 to protrude (e.g., externally protrude or extend) from the case 400. In the present embodiment, the connector 240 extends from an end of the PCM 200 (e.g., the right end of the PCM 200) so the hole 450 through which the connector 240 penetrates may be formed in a portion of the side wall 401 that is adjacent to the PCM loading structure 410, which will be described later.

The lower rib 402 that is vertically bent (e.g., extends in a vertical direction) with respect to the side wall 401 may be formed to cross (e.g., extend across) at or near a center of the case 400. The PCM loading structure 410 in which the PCM 200 is located (e.g., loaded) and a temperature sensor loading structure 420 (e.g., temperature sensor loading unit) in which the temperature sensor 260 is located (e.g., loaded or positioned) may both be adjacent to (e.g., arranged on) the lower rib 402.

The PCM 200 may be loaded in (e.g., attached to) the PCM loading structure 410 (e.g., PCM loading unit) formed on the lower rib 402, and after the PCM 200 is loaded, the battery cells 100 may be loaded (e.g., placed) on to the left and right sides of the PCM 200, respectively. The battery cells 100 may be disposed (e.g., located) so that the positive and negative electrode tabs 121 and 122 of each battery cell 100 may face the PCM 200. Here, in order to prevent the battery cells 100 from being detached from the case 400, cell support ribs 403 may be arranged in (e.g., on) the same level (e.g., plane) as the lower rib 402 so as to correspond (e.g., be adjacent) to a side of the battery cells 100.

After the PCM 200 and the battery cells 100 are loaded (e.g., housed) in the case 400, the positive electrode tabs 121 and the negative electrode tabs 122 of the battery cells 100 may be connected (e.g., welded) to the corresponding connection parts 212 of the PCM 200. To do this, holes 411 may be formed at positions (e.g., areas) of the lower rib 402 which correspond to the connection parts 212, so that, for instance, a welding rod may be inserted and withdrawn. As described above with reference to FIG. 2, when the TCO assembly 130 is connected to the negative electrode tab 122, the positive electrode tab 121 of each of the battery cells 100, and the second auxiliary lead 133 of the TCO assembly 130 may be connected (e.g. welded) to the corresponding connection parts 212 of the PCM 200.

As described above, the battery cells 100 may be loaded (e.g., housed) after a position of the PCM 200 is fixed, and then the electrode tabs 121 and 122 of the battery cells 100 and the PCM 200 may be easily connected (e.g., welded) through the holes 411 formed on the lower rib 402, so that time required to assemble the battery pack may be decreased.

The bottom surface of the case 400 may be open or substantially open, except for portions corresponding to the lower rib 402 and the cell support ribs 403 corresponding (e.g., adjacent) to the side of the battery cell 100, and the top surface of the case 400 may be substantially or entirely open to house (e.g., accommodate) the PCM 200 and the battery cells 100. Because the top and bottom surfaces of the case 400 may be open, it is possible to reduce a thickness thereof so that an entire thickness of the battery pack may be decreased. The case 400 that houses the PCM 200 and the battery cell 100 may be surrounded (or substantially surrounded) by the seals 510 and 520. In order to ensure fire-retardancy of the battery pack, the seals 510 and 520 may be formed of a fire-retardant film.

Hereinafter, with reference to FIGS. 3 through 5, a structure of the case 400 and an assembled structure of the case 400 in which the PCM 200 and the connector 240 are loaded will now be described in detail.

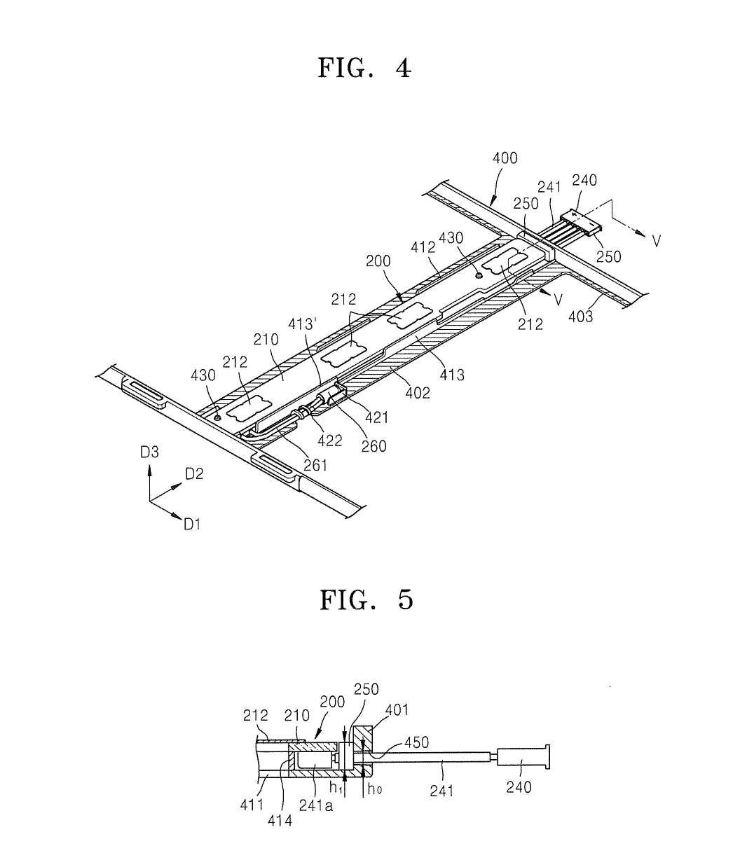

FIG. 3 is an exploded perspective view illustrating the case 400 and the PCM 200 of the battery pack of FIG. 1, FIG. 4 is a perspective view illustrating the case 400 of FIG. 3 in which the PCM 200 and the connector 240 are assembled or attached together, and FIG. 5 is a cross-sectional view of the assembly of FIG. 4, taken along a line V-V of FIG. 4.

Referring to FIG. 3, a first partition wall 412 and second partition walls 413 and 413′ are separated from each other by a width that is substantially equal to a width of the PCM 200 and may be arranged (e.g., located or formed) at (e.g., adjacent to) the PCM loading structure 410. The first partition wall 412 and the second partition walls 413 and 413′ are separated from each other by at least the width of the PCM 200, and the PCM 200 is interposed (e.g., located) between the first partition wall 412 and the second partition wall 413. As illustrated in FIG. 4, a position of the PCM 200 may be restricted (e.g., supported) between the first partition wall 412 and the second partition walls 413 and 413′.

At least one supporting member 414 may be positioned (e.g., formed or located) between the first partition wall 412 and the second partition walls 413 and 413′ and may extend (e.g., upwardly extend) in a thickness direction of the case 400 so as to partially support the PCM 200. Here, a height of the supporting member 414 may be less than a height of the case 400, e.g., a height of the side wall 401. Some of a plurality of the supporting members 414 may partially support the PCM 200 by contacting the protective device 220 adjacent to a bottom surface of the substrate 210.

In order to allow the PCM 200 to be fixed at (e.g., attached to) the PCM loading structure 410, the PCM 200 may have a guide hole 230, and the PCM loading structure 410 may have a guide pin 430. One or more guide holes 230 may be formed in the substrate 210, and one or more guide pins 430 may be formed at the lower rib 402 and protrude (e.g., upwardly protrude) therefrom so as to correspond to the one or more guide holes 230. As illustrated in FIG. 4, the PCM 200 may be fixed at (e.g., or attached to) the case 400 when the one or more guide pins 430 are inserted into the one or more corresponding guide holes 230.

The temperature sensor loading structure 420 may be arranged in parallel with a longitudinal direction of the PCM loading structure 410 and may be disposed (e.g., located) in one of the sides of the PCM loading structure 410. Thus, a temperature sensor 260 may be positioned at a side of the PCM 200 and/or aligned in parallel with the PCM 200. The temperature sensor loading structure 420 may have a third partition wall 421 that partially defines a space in which the temperature sensor 260 is located (e.g., arranged) and a supporting member 422 that may further position (e.g., locate) the temperature sensor 260. In the present embodiment, the third partition wall 421 partially defines the space in which the temperature sensor 260 is arranged, but the second partition wall 413′ may partially locate (e.g., control) the PCM 200, along with the first partition wall 412. Simultaneously, the second partition wall 413′ may partially define the space in which the temperature sensor 260 is located (e.g., arranged) in cooperation with the third partition wall 421.

The third partition wall 421 partially surrounds the temperature sensor 260, such as the thermistor, so that the third partition wall 421 partially defines a space in which the temperature sensor 260 is located (e.g., arranged) and separates the temperature sensor loading structure 420 from another space in the case 400. The temperature sensor 260 that is located (e.g., housed or accommodated) in the space, which is separated from the PCM 200 and the battery cell 100 by the third partition wall 421, may be substantially protected against external shocks.

The supporting member 422 may have a hook shape that upwardly protrudes from the lower rib 402 and may fix (e.g., support) the cable 261 that connects the temperature sensor 260 and the PCM 200. Because the cable 261 is inserted into (e.g., fixed to) the supporting member 422, a position of the temperature sensor 260 may be fixed.

A procedure in which the PCM 200 and the connector 240 are loaded (e.g., housed) in the case 400 will now be described below.

As illustrated in FIGS. 3 through 5, the connector 240 that is connected to the PCM 200 via the cable 241 is exposed (e.g., externally exposed) outside the case 400 by penetrating (e.g., extending) through the hole 450 formed at (e.g., in or through) the side wall 401, and the PCM 200 is located (e.g., housed or fixed) at the PCM loading structure 410. Here, the cable 241 may extend in (e.g., parallel to) a longitudinal direction of the PCM 200, and an end 241a of the cable 241 may be connected (e.g., welded) to the PCM 200. The connector 240 may be arranged at the other end (e.g., the end opposite the end 241a) of the cable 241. For example, the end 241a of the cable 241 may be welded to a rear (e.g., bottom) side (e.g., surface) of the substrate 210. The connector 240 may be formed to have a size appropriate to penetrate through the hole 450, thereby being exposed outside the case 400 via the hole 450. The guide pin 430 may be inserted into the guide hole 230 so that the PCM 200 may be coupled (e.g., fixed) to the case 400.

When the connector 240 penetrates through the hole 450, the sealing member 250 that is arranged in the same axial-direction as the protrusion direction of the connector 240 may block (e.g., seal) the hole 450. For example, as illustrated in FIGS. 4 and 5, the sealing member 250 contacts or substantially contacts the inner side surface (e.g., inner side) of the case 400 (e.g., an inner side of the side wall 401 of the case 400) in which the hole 450 is formed so that the hole 450 may be blocked (e.g., sealed).

The hole 450 may be sized sufficiently to allow the connector 240 to penetrate (e.g., extend or pass) therethrough. For example, a width and height of the hole 450 may be sufficient to allow the connector 240 to penetrate therethrough. A height h₀ of the hole 450 may be equal to or less than 1 mm, in consideration of the Underwriters Laboratories (UL®) Inc. standard. The height h₀ of the hole 450 may be less than a height of the side wall 401, in consideration of its relation with the sealing member 250.

The sealing member 250 may have the same size as the hole 450. In one embodiment, the size of the sealing member 250 is greater than the size of the hole 450. For example, the area of a first outer side surface (e.g., first outer side) of the sealing member 250 which is adjacent to (e.g., contacts) the inner surface of the case 400 may be larger than the cross-sectional area of the hole 450 so that the sealing member 250 may block (e.g., seal) the hole 450 by contacting the inner side surface of the case 400 (e.g., the inner side of the side wall 401 of the case 400). In one embodiment, a height h₁ of the sealing member 250 is greater than the height h₀ of the hole 450, so that an inside of the case 400 is not exposed (e.g., externally exposed) via the hole 450. Also, a width of the sealing member 250 may be greater than a width of the hole 450.

As described above, when the connector 240 is exposed via the hole 450 and the PCM 200 is fixed (e.g., attached) to the PCM loading structure 410 in the case 400, the sealing member 250 may block (e.g., seal) the hole 450 by contacting the inner side surface of the case 400.

The first outer side surface (e.g., first outer side) of the sealing member 250 is adjacent to (e.g., contacts) the case 400. More particularly, the inner side surface (e.g., inner side) of the side wall 401 in which the hole 450 is formed contacts a second outer side surface (e.g., second outer side) of the sealing member 250, which is arranged in an opposite direction to the first outer side surface faces an end of the substrate 210 of the PCM 200. For example, the second outer side surface of the sealing member 250 may contact the end of the substrate 210. Because the sealing member 250 is interposed (e.g., located) between the end of the PCM 200 and the inner side surface of the case 400, the sealing member 250 may fill a gap (e.g., a space) between the PCM 200 and the case 400, and simultaneously, the end of the PCM 200 may contact and apply a pressure to the sealing member 250 so that contact between the first outer side surface of the sealing member 250 and the case 400 may be maintained.

As described above, according to the one or more of the above embodiments of the present invention, the hole through which the connector extends (e.g., penetrates) is formed in the case, the connector protrudes from the case, and the sealing member blocks (e.g., seals) the hole formed in the case so that the battery pack may be easily assembled.

Also, since the sealing member includes the fire-retardant material, the fire-retardancy of the battery pack may be easily achieved.

It should be understood that the exemplary embodiments described herein should be considered in a descriptive sense only and not for purposes of limitation. Descriptions of features or aspects within each embodiment should typically be considered as available for other similar features or aspects in other embodiments.

While the battery pack of the present invention has been described in connection with what is presently considered to be practical, exemplary embodiments, it is to be understood that the invention is not limited to the disclosed embodiments, but rather is intended to cover various modifications and equivalent arrangements included within the spirit and scope of the appended claims.

1. A battery pack comprising:
a battery cell;
a protection circuit module (PCM) electrically coupled to the battery cell;
a case comprising internally defined positions for housing the battery cell and the PCM and having a hole;
a connector extending through the hole and protruding from the case, the connector electrically coupling the battery cell to an external device; and
a sealing member in the case and located substantially parallel to an extending direction of the connector and adjacent to an inner side of the case and sealing the hole.

2. The battery pack of claim 1, wherein the hole is in a side of the case, and the side extends in a thickness direction of the case.

3. The battery pack of claim 1, wherein the sealing member comprises a fire-retardant material.

4. The battery pack of claim 1, wherein a height of the sealing member is greater than a height of the hole.

5. The battery pack of claim 1, wherein a cross-sectional size of the sealing member is greater than a cross-sectional size of the hole.

6. The battery pack of claim 1, wherein a cable extends from an end of the PCM through the sealing member and electrically couples the PCM to the connector.

7. The battery pack of claim 1, wherein the sealing member is between an end of the PCM and the inner side of the case.

8. The battery pack of claim 7, wherein the end of the PCM contacts the sealing member, and a first outer side of the sealing member contacts the inner side of the case.

9. The battery pack of claim 7, wherein a first outer side of the sealing member contacts the inner side of the case, and a second outer side of the sealing member, opposite to the first outer side, faces the end of the PCM.

10. The battery pack of claim 1, wherein the case has a frame shape comprising a side wall extending in a thickness direction and substantially surrounding the battery cell and the PCM, and a lower rib extending vertical to the side wall and having a space configured for loading the PCM.

11. A battery pack comprising:
a battery cell;
a protection circuit module (PCM) electrically coupled to the battery cell;
a case comprising internally defined positions for housing the battery cell and the PCM and having a hole;
a cable coupling a connector to the PCM and protruding through the hole; and
a sealing member substantially parallel to a protrusion direction of the connector and sealing the hole.

12. The battery pack of claim 11, wherein a first outer side of the sealing member contacts an inner side of the case, and the sealing member comprises a fire-retardant material.

13. The battery pack of claim 12, wherein a second outer side of the sealing member, opposite to the first outer side, faces an end of the PCM.

14. The battery pack of claim 11, wherein the cable extends through the sealing member.

15. The battery pack of claim 11, wherein the hole is in a side of the case, and the side extends in a thickness direction of the case.

16. A battery pack comprising:
a battery cell;
a protection circuit module (PCM) electrically coupled to the battery cell;
a case comprising internally defined positions for housing the battery cell and the PCM and having a hole;
a connector extending through the hole and protruding from the case, the connector electrically coupling the battery cell to an external device; and
a sealing member between an end of the PCM and an inner side of the case and sealing the hole.

17. The battery pack of claim 16, wherein a cable electrically couples the connector to the PCM and extends through the sealing member.

18. The battery pack of claim 16, wherein a first outer side of the sealing member contacts an inner side of the case.

19. The battery pack of claim 16, wherein the sealing member comprises a fire-retardant material.

20. The battery pack of claim 16, wherein a height of the sealing member is greater than a height of the hole.

21. A boat comprising an electric motor powered by the battery pack of claim 1.
